(19) United States
(12) Patent Application Publication
(10) Pub. No.: US 2024/0198147 A1
(43) Pub. Date: Jun. 20, 2024

(54) Anti-Torque Safety Hook

(71) Applicant: BEXUS INDUSTRIES CO., LTD., Taichung City (TW)

(72) Inventors: Kai Chieh Yang, Taichung City (TW); Yi-Ching Lin, Taichung City (CN)

(21) Appl. No.: 18/416,822

(22) Filed: Jan. 18, 2024

Related U.S. Application Data
(63) Continuation-in-part of application No. 17/232,082, filed on Apr. 15, 2021, now Pat. No. 11,931,606.

(51) Int. Cl. A62B 35/00; F16B 45/02

(52) U.S. Cl. CPC A62B 35/0068; F16B 45/023; F16B 45/028

(57) ABSTRACT

An anti-torque safety hook includes a main body and a gate member. The main body has a hook opening, an opening communicating to the right side of the hook opening, a hook nose arranged above the opening, a hook eye arranged below the hook opening, and an energy absorption area arranged on the left side of the hook opening. The gate member has a first end mounted on the main body and a second end comprising a male buckle, adapted for detachably coupled with the hook nose to allow the gate member to open and close the opening. When the main body bears a lateral load of 3000 pounds, the energy absorption area allows the main body to distort in response while the gate member may still close the opening to prevent the risk of decoupling and in order to meet the standard of ANSI/ASSP Z359.12-2019.

### CROSS REFERENCE OF RELATED APPLICATION

This is a Continuation-In-Part application that claims the benefit of priority under 35U.S.C.§ 120 to a non-provisional application, application Ser. No. 17/232,082, filed Apr. 15, 2021.

### BACKGROUND OF THE PRESENT INVENTION

### Field of Invention

The present invention relates to the field of safety hook, and more particularly to an anti-torque safety hook that meets the standard of ANSI/ASSP Z359.12-2019.

### Description of Related Arts

It is noted that every personnel has to fasten a safety belt under an upper air operation scenario, such as rock climbing, mountain climbing, building construction, and etc. The free end of the safety belt has a safety hook connected thereon for buckling with a preset upper air anchor point, so that when the person falls, s/he will be hung in the air and allowed to wait for rescue.

However, when the person falls, the safety hook bears not only the downward pulling force and impact force, but also the load imposed by the lateral collision at the anchor point or upper air environment. Therefore, there is a standard of ANSI/ASSP Z359.12-2019 Connecting Components for Personal Fall Arrest Systems, which further regulates that the safety hook will not be broken or unhooked when the safety hook bears a lateral load. Hence, all current manufacturers have to redevelop safety hooks that meet the standard.

### SUMMARY OF THE PRESENT INVENTION

A main purpose of the present invention is to provide an anti-torque safety hook, wherein an energy absorption area is located on a hook body of the safety hook, so that when the safety hook is impacted, the energy absorption area first bears an impact force to ensure that the gate will not separate from the hook nose.

The purpose of the present invention is to provide an anti-torque safety hook, wherein the hook head is clamped by the front and rear boards of the hook body. In this way, the thickness of the hook body is greater than the thickness of the hook head, when the safety hook is impacted, the hook body will first contact the collision object, and absorb the impact force and produce deformation, thereby ensuring that the gate member of the safety hook does not separate from the hook nose of the hook head.

In order to achieve the above purpose, the present invention provides an anti-torque safety hook, including:
a main body, having a hook head, a hook body connected with a top end of the hook head, a hook opening passing through the front and back sides thereof, a opening communicating to the right side of the hook opening, a hook nose arranged at a free end of the hook head and located above the opening, a hook eye arranged below the hook opening, and an energy absorption area arranged on the hook body and located to the left side of the hook opening, wherein the opening has a dimension of more than 1 inch from the top end to the bottom end thereof;
a gate member, having a first end mounted on the main body and a second end comprising a male buckle, adapted for detachably coupled with the hook nose, so as to allow the gate member to open and close the opening; and
a detent member, coupled on the main body and maintained at a first position, so as for ensuring that the gate member closes the opening, wherein when the detent member is operated and switched to a second position, the safety is disarmed, wherein when an anchor point is buckled into the hook opening through the opening to hang the safety hook, the anchor point abuts the top end of the hook opening as a fulcrum, and a lateral load of 3600 pounds is applied to the hook eye, wherein two resistance points located directly above the energy absorption area and above the hook nose, the energy absorption area is sufficient to provide deformation response to the main body, ensuring that the gate member does not detach from the hook nose and effectively controlling a gap between the gate member and the hook nose to not exceed 0.125 inches.

In order to achieve the above purpose, the present invention also provides an anti-torque safety hook, including:
a hook body;
a hook head, one end of which is connected to the hook body, and defines a hook opening that runs through the front and rear directions of the safety hook and forms an opening between the free end of the hook head and the hook body that communicates with the hook opening; and
a gate member, having a first end mounted on the main body and a second end comprising a male buckle, adapted for detachably coupled with the hook nose, so as to allow the gate member to open and close the opening, wherein the thickness of the hook body is greater than the thickness of the hook head, when the gate member closes the opening and the safety hook falls and collides, the hook body will first contact a collision object, and an impact force will be absorbed by the hook body first to ensure that the hook head does not deform and allows the gate member to close the opening.

In order to achieve the above purpose, the present invention also provides an anti-torque safety hook, including:
a hook head, having a hook nose arranged on the free end thereof;
a hook body, having a symmetrically shaped front board and back board, wherein an end of the hook head is affixed between the top end of the front board and the top end of the back board in a clamping manner to define a hook opening penetrated in the front and back direction of the safety hook and forms an opening between the free end of the hook head and the hook body that communicates with the hook opening;
a hook eye, which includes an intermediate block with a chute clamped and fixed between the bottom end of the front board and the bottom end of the back board, a main bolt that installs the intermediate block on the hook body, and a breaking bolt parallel to the main bolt and arranged on the hook body, and a guide bolt fixed to the hook body through the chute;
a gate member, having a first end mounted on the hook body and a second end comprising a male buckle, adapted for detachably coupled with the hook nose, so as to allow the gate member to open and close the opening; and
a detent member, coupled on a hook body and maintained at a first position, so as for ensuring that the gate member closes the opening, wherein when the detent member is operated and switched to a second position, the safety is disarmed, so that the gate member is operatable for opening the opening.

Accordingly, the present invention utilizes the overall setting of the main body, the energy absorption area, the hook opening, and the opening to meet the standard and requirements of ANSI/ASSP Z359.12-2019, especially the detail criteria of 3.1.3.5 and 3.1.3.6 of the standard.

### BRIEF DESCRIPTION OF THE DRAWINGS

FIG. 1 is an exploded view of the present invention.

FIG. 2 is a front view of an assembled main body according to the present invention.

FIG. 3 is a perspective view of an assembly according to the present invention.

FIG. 4 is a sectional view of the assembly according to the present invention.

FIG. 5 is a front view illustrating an opening being forcefully opened according to the present invention.

FIG. 6 is a sectional view of FIG. 5.

FIG. 7A and FIG. 7B are perspective views illustrating the hook eye according to the present invention when buffering a falling person.

FIG. 8 is a perspective view illustrating the present invention using a jig to simulate a static test lateral load.

FIG. 9 is a front view illustrating the present invention after being subjected to simulated static test lateral loads.

FIG. 10 is a left view of FIG. 9.

FIG. 11 is a perspective view illustrating the position of the linear resistance point of the present invention.

FIG. 12 is a perspective view illustrating the present invention for dynamic testing with lateral loading.

### DETAILED DESCRIPTION OF THE PREFERRED EMBODIMENT

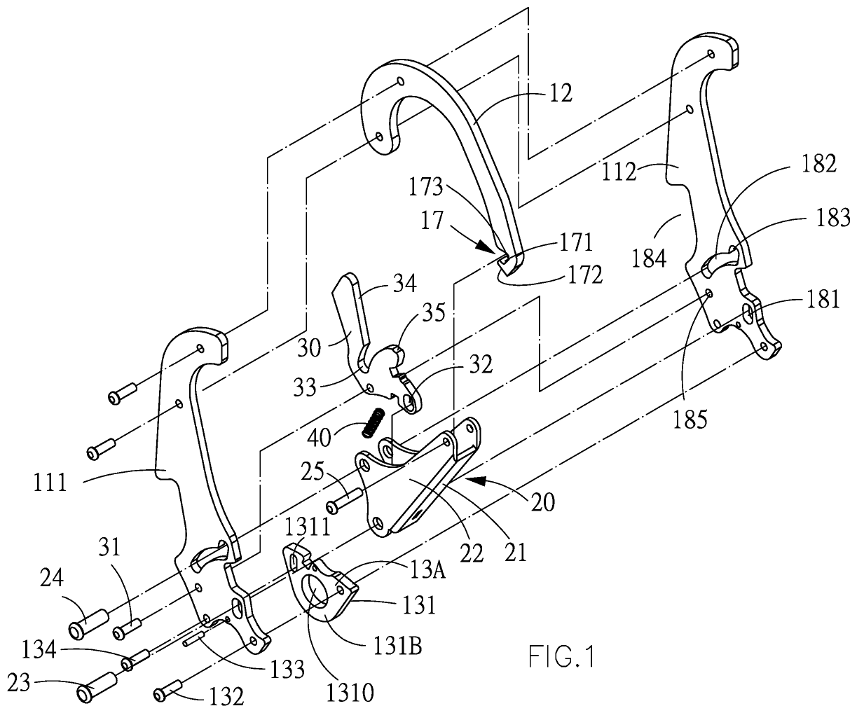

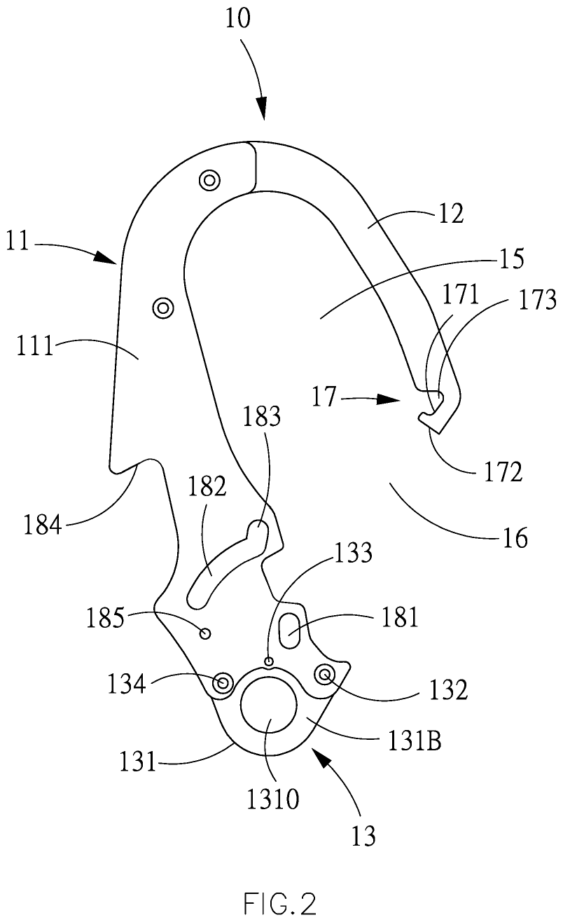

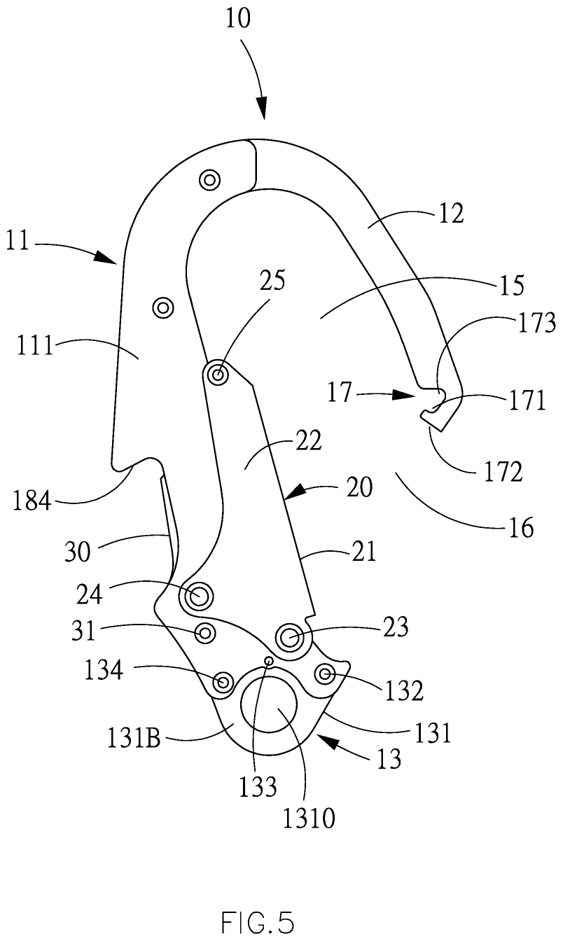

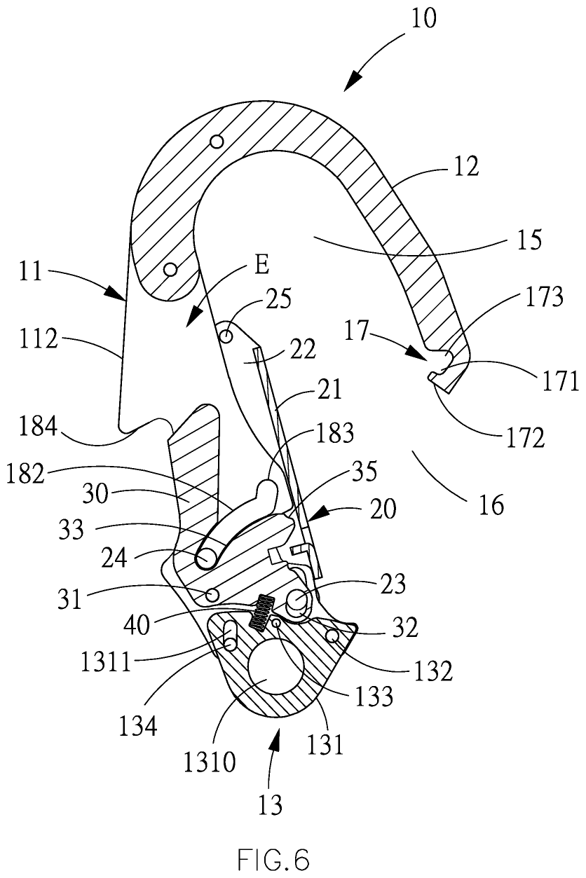

Referring to FIGS. 1-7, the present invention provides an anti-torque safety hook, including a main body 10 with a gate member 20, a detent member 30, and a spring 40 arranged thereon.

The main body 10 includes a hook body 11, a hook head 12, a hook eye 13, and an energy absorption area E.

The hook body 11 has a symmetrically shaped front board 111 and back board 112, wherein an end of the hook head 12 is affixed between the top end of the front board 111 and the top end of the back board 112 in a clamping manner. Besides, the hook head 12 is riveted on the top end of the hook body 11 in an integrally connected manner, so as to define a hook opening 15 on the main body 10 that penetrates in the front and back direction. An opening 16 is provided to communicate with the hook opening 15 from the right side thereof between the right side (as illustrated in the drawings) of the hook body 11 and the free end of the hook head 12, so as to allow an anchor point in the upper air to be buckled into the hook opening 15 by the opening 16. After the gate member 20 closes the opening 16, the anchor point will be capable of supporting the main body 10 without decoupling or escaping therefrom. The opening 16 of the present invention has a dimension of more than 1 inch from the top end to the bottom end thereof. The free end of the hook head 12 is defined as a hook nose 17. The hook nose 17 is located at the top end of the opening 16 and has a slot 171 communicating with the hook opening 15, a mouth piece 172 arranged between the slot 171 and the opening 16, and a deep area 173 connected and communicated with the top end of the slot 171. Besides, a first groove 181 penetrates the front board 111 and the back board 112 below the opening 16. A second groove 182 is provided in a penetrating manner above the first groove 181, wherein the second groove 182 is arranged in a curvy manner for the first groove 181 as the center, wherein the right side of the second groove 182 is upwardly connected with a third groove 183. A fourth groove 184 is provided and arranged above the second groove 182 on the left side of the front board 111 and the back board 112. A first hole 185 provided in a penetrated manner between the left ends of the first groove 181 and the second groove 182.

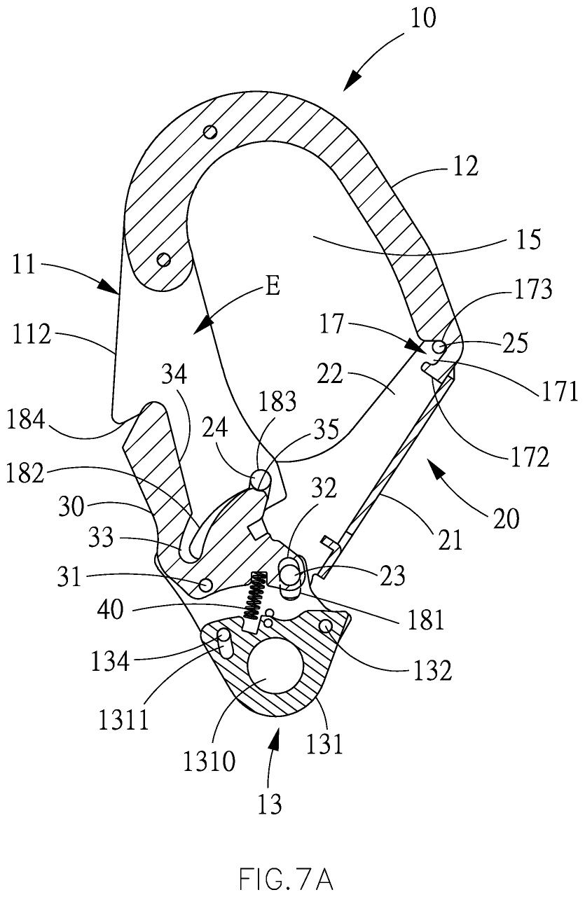

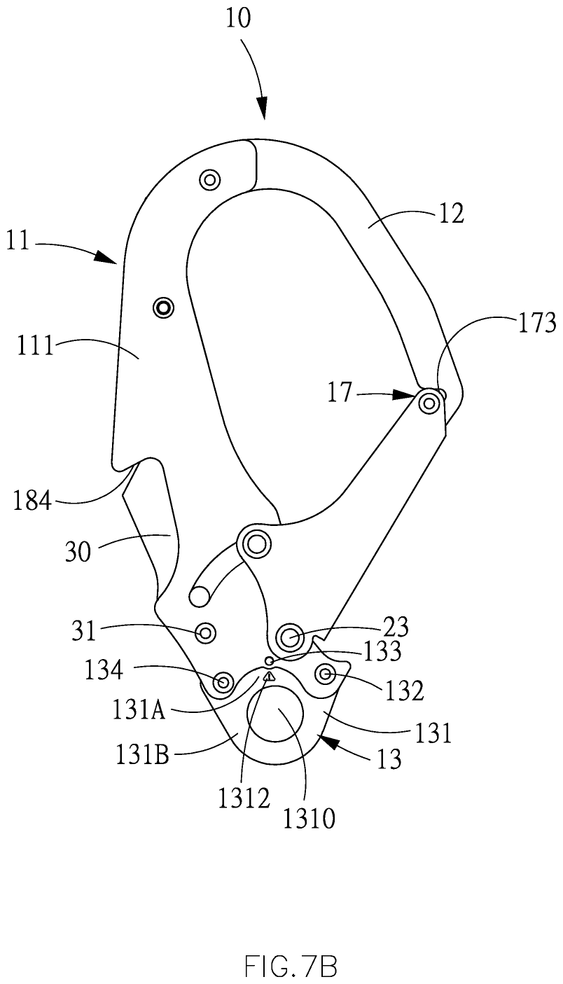

The hook eye 13 is mounted at the bottom of the hook body 11 and is located below the hook opening 15 and the first groove 181, which is formed by the intermediate block 131, the main bolt 132, and the breaking bolt 133, wherein the intermediate block 131 has a covered portion 131A and a bare portion 131A, wherein the covered portion 131A is clamped between the bottom end of the front board 111 and the bottom end of the back board 112 and is affixed through the pinning of the main bolt 132 and the breaking bolt 133 so as to be integrally bonded. The main bolt 132 and the breaking bolt 133 are parallel to each other. The strength of the breaking bolt 133 is weaker than it of the main bolt 132. The bare portion 131B has a hanging hole penetratingly arranged thereon. The hanging hole 1310 is for the connection of the safety belt on the back of the user, so that the impact rendered by the falling of the user will be exerted onto the hook body 11 through the intermediate block 131. As a result, as illustrated in FIG. 7A, during the process that the main bolt 132 and the breaking bolt 133 transfer the impact to the main body 10, the breaking bolt 133 will break first, so as to first buffer the impact in order to reduce the force exerted to the front board 111 and the back board 112, such that the front board 111 and the back board 112 may gradually distort based on the design to respond to the force and keep hanging the user in the air, rather than lead danger of breaking the main body 10. In order to reduce unnecessary wobbling of the user hanging in the air due to utilizing the main bolt 132 as the point of support after the breaking bolt 133 has broken from the intermediate block 131. A chute 1311 may be provided and arranged at the covered portion 131A of the intermediate block 131 and a guide bolt 134 may be provided and affixedly arranged on the front board 111 and the back board 112 to penetrate the chute 1311, so that when the breaking bolt 133 has not broken, the guide bolt 134 is kept at the original position of the chute 1311, while when the breaking bolt 133 has broken, the chute 1311 will position the guide bolt 134 to a designated position, so that the intermediate block 131 may both rely on the main bolt 132 and the guide bolt 134 to support the hanging of the user. Preferably, the breaking bolt 133 is located between the main bolt 131 and the guide bolt 134. It is worth noticing that according to the present invention, the intermediate block 131 may have a warning sign 1312 arranged on the covered portion 131A, such that when the main body 10 bears a relatively low impact that only breaks the breaking bolt 133 while the main body 10 has not distorted, as illustrated in FIG. 7A and FIG. 7B, the warning sign 1312 will be revealed, so as to warm the user not to repetitively utilize the device subsequently, but to send it to the manufacturer for services.

The energy absorption area E is arranged on the hook body 11, so as to be on the left side of the hook opening 15 and face to the hook nose 17 and the opening 16. The energy absorption area E is located between the hook head 12 and the hook eye 13 and a channel is formed and provided between the back side of the front board 111 and the front side of the back board 112. The top end of the energy absorption area E is clamped and held between the front board 111 and the back board 112 through an end of the hook head 12. The bottom end of the energy absorption area E is clamped and held between the front board 111 and the back board 112 through the covered portion 131A of the intermediate block 131. Accordingly, the energy absorption area E has an inner wall arranged in an oblong-shaped manner and laterally passing through the left and right side of the hook body 11, so that the right end of the energy absorption area E communicates with the hook opening 15 and both the hook nose 17 and the opening 16 are arranged to be in the right area of the energy absorption area E, so that when the main body 10 bears a lateral load, the energy absorption area E has enough allowance for not only the front board 111 and the back board 112 to distort in response, but also the buffer provided for the hook nose 17 and the gate member 20. The first groove 181, the second groove 182, the third groove 183, the fourth groove 184, and the first hole 185 are all in the lower portion of the energy absorption area E. In order for the front board 111 and the back board 112 to gradually distort based on the design, the front board 111 and the back board 112, according to the present invention, can choose to utilize material with better toughness, while the hook head 12 and the intermediate block 131 can choose to utilize metal material with higher rigidity. Alternatively, the hook body 11 and the hook head 12 may be optionally integrally formed with the same material and be further shaped through cutting or forming, so as to form the energy absorption area E on the hook body 11, which allows the energy absorption area E to have an oblong-arranged inner wall and laterally pass through the left and right side of the hook body 11, which is an equal variation implemented of the present invention.

The section of the gate member 20 is approximately in a reverse-U shape, so as to have a baffle 21 capable of closing the opening 16 and two side boards symmetrically bent from the two sides of the baffle 21, wherein the two side boards respectively have a first end and a second end opposite to each other, wherein the first end covers the first groove 181 and the third groove 183 so as to bridge with the first axle 23 that passes through the upper part of the first groove 181 and to bridge with the second axle 24 that passes through the third groove 183, such that the first end of the gate member 20 can be mounted on the hook body 11 through two pivots. A male buckle 25 is bridged and connected with the two side boards 22 on the second end of the gate member 20. The male buckle 25 is buckled into the slot 171 of the hook nose 17 and limited in the deep area 173 so as to have the gate member 20 close the opening 16. If the opening 16 is to be opened, the detent member 30 has to be pressed, so as to force the gate member 20 to move downward so as to move the first axle 23 to the lower part of the first groove 181 and to move the second axle 24 downward to the second groove 182 at the same time, which drives the male buckle 25 to move downward and escape from the deep area 173. Then the gate member 20 may be forced to swing counterclockwise toward the inside of the hook opening 15 with the first axle 23 as the pivot, so as to drive the second axle 24 to move along the second groove 182 and to drive the male buckle 25 to decouple and escape from the slot 171 of the hook nose 17, so as to allow the gate member 20 to open the opening 16. When the gate member 20 abuts against the right side of the hook body 11, the opening 16 is completely opened.

The detent member 30 is slidingly arranged on the lower portion of the energy absorption area E of the hook body 11 and coupled with the first hole 185 through the third axle 31. Besides, the detent member 30 also has a fifth groove 32 arranged thereon corresponding to the first groove 181, wherein the fifth groove 32 is for the first axle 23 to pass therethrough, so that the detent member 30 can be pivotally coupled with the hook body 11 through the first axle 23 and the third axle 31 and able to reach in and out in the fourth groove 184 in order to shift between the first position and the second position. In fact, the detent member 30 has a sixth groove 33 with the same radian measure with the second groove 182. The right side of the sixth groove 33 is arranged in an open manner and has a pushing and drawing side 34 connected upward and a locking side 35 extended downward. When the gate member 20 closes the opening 16, which positions the second axle 24 in the third groove 183, the locking side 35 will abut against the bottom end of the second axle 24, so as to ensure and secure closure of the opening 16 by the gate member 20. At this moment, the detent member 30 is maintained at the first position. Here, the detent member 30 in the fourth groove 184 is in an extended mode. However, when the detent member 30 is pressed and turned into a retracted mode in the fourth groove 184, the detent member 30 will be switched to a second position, which drives the locking side 35 to release the second axle 24 for disarming the above mentioned safety, so as to allow the gate member 20 to move down subsequently, which, at the same time, overlaps the sixth groove 33 and the second groove 182, shifts the first axle 23 to the lower part of the fifth groove 32 and first groove 181, moves the second axle 24 down into the second groove 182 and the sixth groove 33, as well as withdraws the male buckle 25 from the deep area 173. Then, the gate member 20 may be swung counterclockwise toward the inside of the hook opening 15 with the first axle 23 as the pivot, so as to drive the second axle 24 to move along the second groove 182 and the sixth groove 33 to decouple and disengage the male buckle 25 from the hook nose 17, so as for opening the opening 16, which allows the device of the present invention to buckle with a preset upper air anchor point.

The spring 40 is mounted between the detent member 30 and intermediate block 131, so as to provide a predetermined force for the detent member 30, so as to keep the detent member 30 at the first position to ensure and secure that the gate member 20 close the opening 16, such that the anchor point will not escape from the hook opening 15. However, when the user falls and uses the present invention to bear the load imposed by a lateral collision at the anchor point or upper air environment, the bottom end of the main body 10 can be relatively bent toward the top end of the main body 10, so that the energy absorption area E allows the hook body 10 to distort in response. Meanwhile, the energy absorption area E can also provide buffer the gate member 20, the male buckle 25, and the hook nose 17 at the same time, so as to prevent the male buckle 25 from leaving and disengaging from the hook nose 17, so as to ensure and secure that the gate member 20 is able to maintain closing the opening 16, which therefore prevents the anchor point from escaping and decoupling and meets the standard of ANSI/ASSP Z359.12-2019.

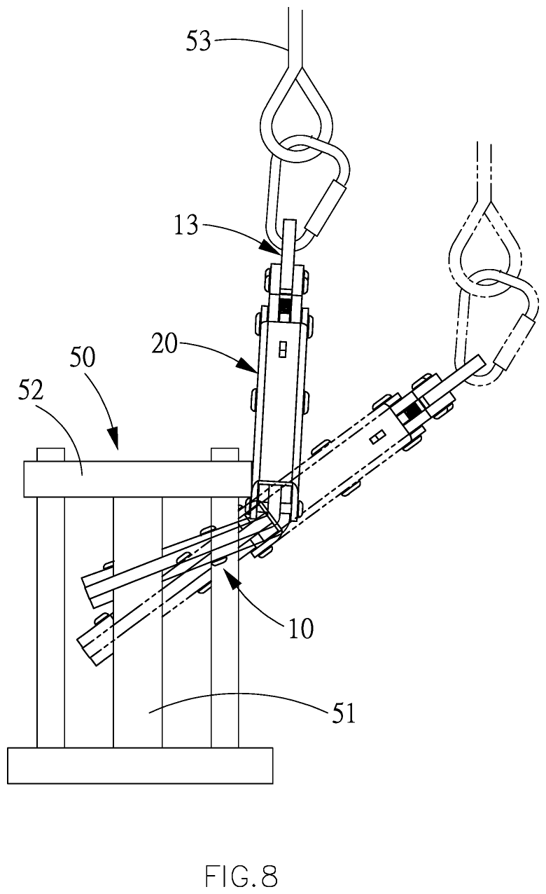

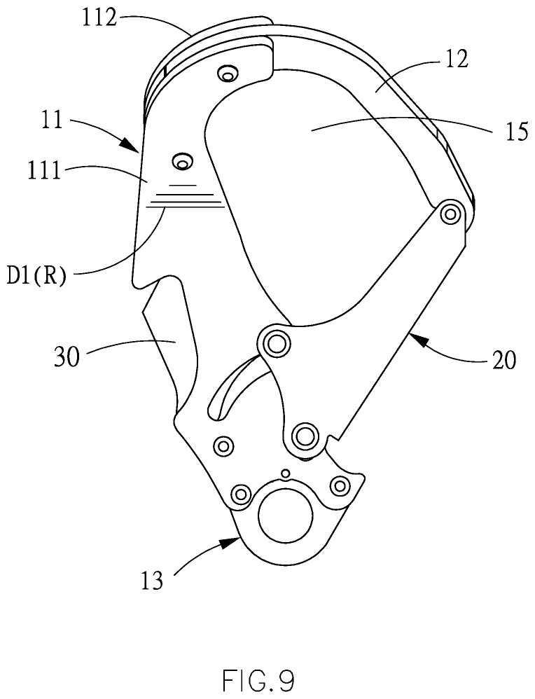

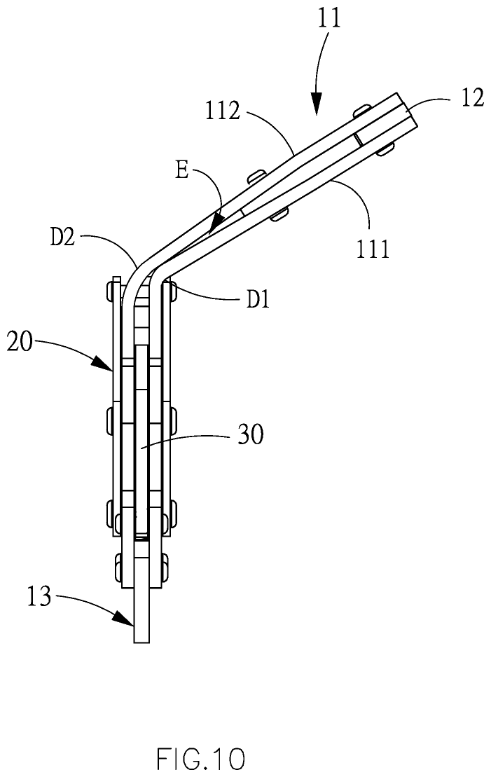

Referring to FIGS. 8-10, the manner that the anti-torque safety hook of the present invention is able to meet the criteria of the 3.1.3.5 of the above-mentioned standard is further illustrated. A column 51 of a jig 50 is utilized to simulate an anchor point for the static testing for the main body 10 and the gate member 20, wherein the jig 50 has a resistance base 52 horizontally protruded and provided on a top end of the column 51. The gate member 20 and the detent member 30 are operated to lock the column 51 within the hook opening 15, so that the main body 10 is laterally place against the jig 50. Then, a power source 53 linked to the hook eye 13, and the hook eye 13 is pulled upward to simulate the load required for continuously hanging a falling person. Therefore, when the power source 53 is turned on, the bottom end and the top end of the main body 10 will bear a lateral load due to the extrusion and impact from the edge of the resistance base 52. As a result, the bottom end of the main body 10 will be bent toward the top end of the main body 10 relatively. Here, according to the present invention, the energy absorption area E is certainly capable of allowing the hook body 11 to distort in response, which allows the portion of the back board 112 abutting against the edge of the resistance base 52 to be pushed and bent toward the energy absorption area E and create a pressing zone D1. As for the portion corresponding to the front board 111 may create a stretching zone D2 due to the bent and distorted energy absorption area E. Because the gate member 20, male buckle, and hook nose are in the right area of the energy absorption area E, the pressing zone D1 and the stretching zone D2 not only keep the main body 10 from being broken, but also effectively control the male buckle from releasing the hook nose, so that the gate member 20 can still stay closing the hook opening 15, which therefore prevents the hook opening 15 from disengaging from the column 51 (anchor point).

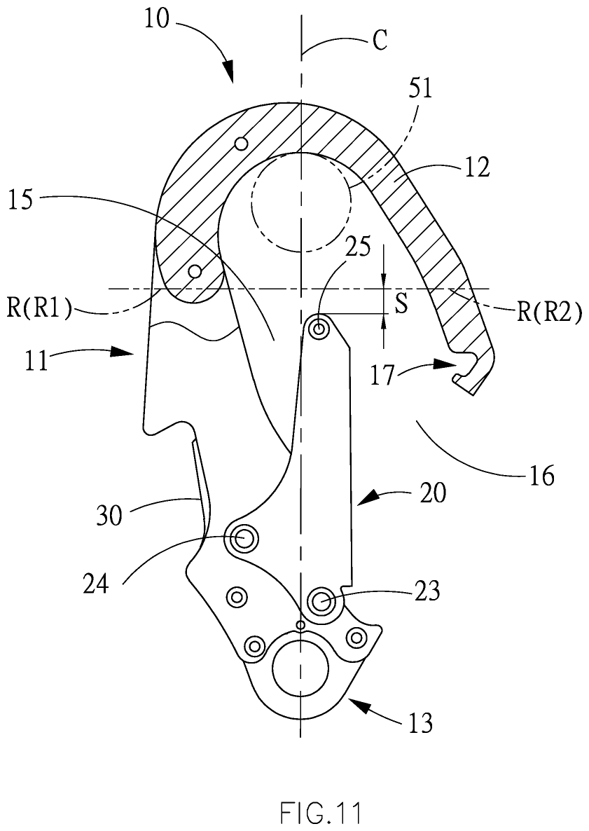

Referring to FIG. 11, the 3.1.3.5 specification stipulates that the front or back surfaces of the upper part of the hook head 12 and the hook body 11 shall be used as the linear resistance points R, respectively. That is to say, the two points directly above the energy absorption area E and above the hook nose 17 of the main body 10 are used as the resistance points R. In this way, when the power source 53 continuously and stably applies an upward load of 3600 pounds to the hook eye 13, the edge of the resistance base 52 acts on the two resistance points R. For convenience of description, the resistance point R above the energy absorption area E is regarded as the first resistance point R1, and the resistance point R above the hook nose 17 is regarded as the second resistance point R2. Because the first resistance point R1 above the energy absorption area E of the present invention is located at the position that the hook head 12 is clamped between the back board 112 and the front board 111, and is also located at the hook body 11, the structural thickness of the first resistance point R1 above the energy absorption area E is symmetrically thickened compared to the structural thickness of the second resistance point R2 above the hook nose 17 of the hook head 12, that is, the thickness of the hook body 11 is greater than the thickness of the hook head 12. In this way, the 3600-pound load will first be applied between the edge of the resistance base 52 and the first resistance point R1 directly above the energy absorption area E, and then, it will be applied between the edge of the resistance base 52 and the second resistance point R2 above the hook nose 17. Therefore, the present invention uses the first resistance point R1 located above the energy absorption area E as the first contact point with the edge of the resistance base 52, so that the energy absorption area E provides the main body 10 deformation response, and then the second resistance point R2 above the hook nose 17 contact with the edge of the resistance base 52, that is, the second resistance point R2 is the next contact point that collides with the edge of the resistance base 52, so that under the sequential action, the stress situation of the second resistance point R2 above the hook nose 17 can be relatively weakened, so as to ensure that the gate member 20 will not be separated from the hook nose 17. Moreover, the gap between the gate member 20 and the hook nose 17 can be effectively controlled to not exceed 0.125 inches.

In order to further clarify the position of the resistance point R, the present invention defines that when the gate member 20 opens the opening 16 and is parallel to the longitudinal centerline C formed by the main body 10, the distance S between the linear resistance point R and the top of the gate member 20 is controlled to not exceed ⅛ inches. Based on the setting requirement of the distance S, the resistance base 52 is installed in the jig 50 in an adjustable position, so that the position of the resistance point R can be corrected in a timely manner.

It can be understood from the above that the hook body 11 is composed of a symmetrical front board 111 and a back board 112, and the energy absorption area E and the first resistance point R1 are both located on the hook body 11. One end of the hook 12 is clamped between the top end of the front board 111 and the top end of the back board 112. The free end of the hook head 12 is defined as a hook nose 17, and the second resistance point R2 is located on the hook head 12. Since the hook head 12 is clamped at the top end of the front board 111 and back board 112 of the hook body 11, the thickness of the hook body 11 is greater than the thickness of the hook head 12, that is, the first resistance point R1 first contacts the resistance base 52. In other words, when a person falls, the impact force on the safety hook will first touch the first resistance point R1 and then the second resistance point R2. In this way, the energy absorption area E can first absorb the lateral load, and simultaneously provide buffering for the gate member 20, the male buckle 25 and the hook nose 17, thereby ensuring that the male buckle 25 cannot be separated from the hook nose 17, so as to ensure that the gate member 20 can still keep the opening 16 closed.

As shown in FIG. 8, since the thickness of the hook body 11 is greater than the thickness of the hook head 12, when the safety hook collides with the resistance base 52, the hook body 11 will first collide with the resistance base 52, and the energy absorption area E will absorb the collision force and produce bending to ensure that the gate member 20 can still maintain the locking hook opening 15.

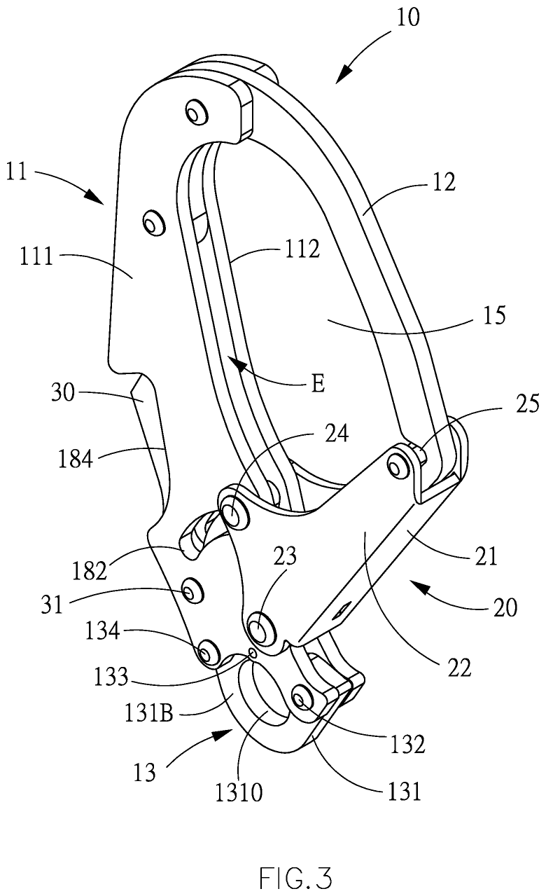

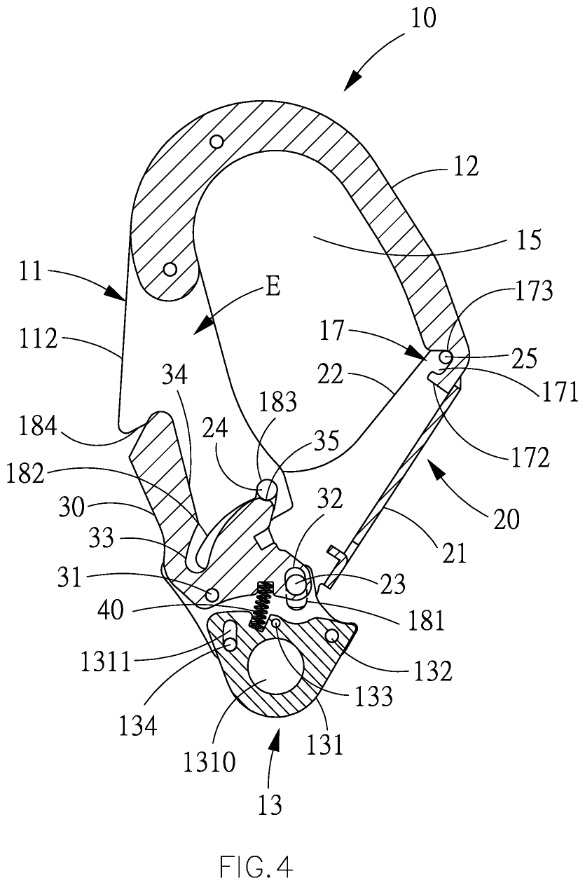

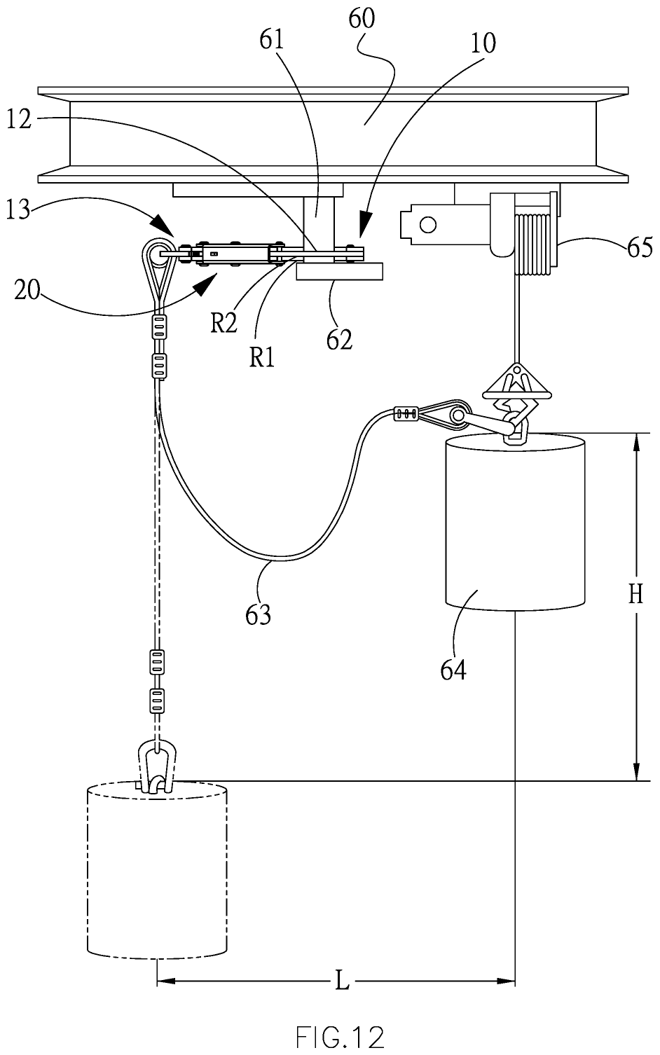

Referring to FIG. 12, which is a schematic view of the dynamic test carried out by the present invention to comply with specification 3.1.3.6 of the standard. It uses an anchorage 60 to vertically install a longitudinal column 61 downward. The bottom end of the longitudinal column 61 is equipped with a resistance plate 62 that can adjust its position laterally. The longitudinal column 61 is located and locked in the hook opening 15, and the main body 10 is laterally placed against the resistance plate 62 so that the first resistance point R1 is in contact with the edge of the resistance plate 62. Then, one end of a lanyard 63 is externally connected to the end of the hook eye 13, and the other end of the lanyard 63 is connected with a counterweight 64. The counterweight 64 is positioned via a hoist 65 at a lateral distance L not exceeding 12 inches from the end of the hook eye 13. In other words, the horizontal distance between an initial position and a dropped position of counterweight 64 is the lateral distance L, and the lateral distance L is defined to be no more than 12 inches. The hoist 65 controls the counterweight 64 to obtain the required drop height H for the 3,600 pound load. In other words, the hoist 65 controls the required drop height H of the counterweight 64, in which the counterweight 64 is 3600 pounds, so that after the hoist 65 quickly releases the counterweight 64, the first resistance point R1 will collide with and squeeze the edge of the resistance plate 62 to bear the lateral load. Furthermore, the vertical distance between the initial position and the dropped position of the counterweight 64 is the height H. When the counterweight 64 falls, the first resistance point R1 will be squeezed and deformed by the edge of the resistance plate 62 first. At this time, as shown in FIGS. 3 and 4 of the present invention, the energy absorption area E does effectively provide the deformation response of the hook body 11, the gate member 20, the male buckle 25 and the hook nose 17 are located in the right range of the energy absorption area E, and the hook head 12 does not necessarily come into contact with the resistance plate 62 when the counterweight 64 falls, so it can ensure that the gate member 20 will not be separated from the hook nose 17, and further effectively control the gap between the gate member 20 and the hook nose 17 to not exceed 0.125 inches.

Further, as shown in FIG. 12, the main body 10 is transversely placed on the resistance plate 62, and the first resistance point R1 is against the edge of the resistance plate 62. Therefore, when a load of 3600 pounds falls, the first resistance point R1 will first collide and squeeze the edge of the resistance plate 62 and bear the transverse load, so that the energy absorption area E located at the hook body 11 will first absorb the collision force and deform. Then, when the second resistance point R2 touches the edge of the resistance plate 62, most of the collision force has already been absorbed by the energy absorption area E first. Therefore, it can be further ensured that the gate member 20 does not break away from the hook nose 17.

According to the present invention, the anti-torque safety hook mainly utilizes the distortion of the energy absorption area E to absorb most of the predetermined torque so as to prevent the main body 10 from being broken and prevent the gate member 20 from opening the opening 16. In this sense, the parameters of the front board 111 and the back board 112, such as thickness, material, distance therebetween, and etc., may vary.

In view of above, the overall structure and arrangement of the anti-torque safety hook according to the present invention is novel and advantageous, which is certainly a great creation of a technical construct and shall match the conditions of patent application. Therefore, it is applied herein in accordance with the law. However, what has been mentioned above is only one of the preferred embodiments of the present invention, which shall not be used to limit the scope of the practice of the present invention. In other words, all equivalent alternatives and modifications according to the claims of the present invention shall still be covered by the claimed scope of the present invention.

What is claimed is:

1. An anti-torque safety hook, comprising:
a main body, having a hook head, a hook body connected with a top end of said hook head, a hook opening passing through the front and back sides thereof, a opening communicating to the right side of said hook opening, a hook nose arranged at a free end of said hook head and located above said opening, a hook eye arranged below said hook opening, and an energy absorption area arranged on said hook body and located to the left side of said hook opening, wherein said opening has a dimension of more than 1 inch from the top end to the bottom end thereof;
a gate member, having a first end mounted on said main body and a second end comprising a male buckle, adapted for detachably coupled with said hook nose, so as to allow said gate member to open and close said opening; and
a detent member, coupled on said main body and maintained at a first position, so as for ensuring that said gate member closes said opening, wherein when said detent member is operated and switched to a second position, the safety is disarmed, wherein when an anchor point is buckled into said hook opening through said opening to hang said safety hook, the anchor point abuts the top end of said hook opening as a fulcrum, and a lateral load of 3600 pounds is applied to said hook eye, wherein two resistance points located directly above said energy absorption area and above said hook nose, said energy absorption area is sufficient to provide deformation response to said main body, ensuring that said gate member does not detach from said hook nose and effectively controlling a gap between said gate member and said hook nose to not exceed 0.125 inches.

2. The anti-torque safety hook, as recited in claim 1, wherein said gate member opens said opening and is parallel to the longitudinal centerline formed by said main body, a distance between said resistance point and the top of said gate member is controlled to not exceed ⅛ inches.

3. The anti-torque safety hook, as recited in claim 2, wherein the structural thickness of said resistance point directly above said energy absorption area is symmetrically thickened than the structural thickness of said resistance point above said hook nose, so that said 3600 pound load will first apply on said resistance point directly above said energy absorption area, and then apply on said resistance point above the hook nose.

4. The anti-torque safety hook, as recited in claim 2, wherein the 3,600 pound load was determined through a static testing, wherein the static test included a jig for horizontal placement of said main body, a column for being locked in said hook opening, a resistance base located at the top end of the column, and a power source externally connected to said hook eye, wherein the power source applies the 3600 pound load upward to pull said hook eye, causing the edge of the resistance base to squeeze said resistance points.

5. The anti-torque safety hook, as recited in claim 2, wherein the 3,600 pound load was determined through a dynamic test, wherein the dynamic test is to lock a longitudinal column in said hook opening, a resistance plate is installed at the bottom of the longitudinal column, so that said main body is laterally placed against the resistance plate, and the resistance point is contacted with the edge of the resistance plate, and then, one end of a lanyard is connected to the end of said hook eye, the other end of the lanyard is fixed with a counterweight, wherein the counterweight is positioned by a hoist at a lateral distance of no more than 12 inches from the end of said hook eye, and the hoist controls the counterweight to obtain the required drop height for the 3,600 pound load, allowing the dynamic test to be performed after the hoist quickly releases the counterweight.

6. The anti-torque safety hook, as recited in claim 1, wherein the gate member, male buckle and hook nose are located on the right side of said energy absorption area.

7. The anti-torque safety hook, as recited in claim 6, wherein said energy absorption area arranged between said hook eye and the top of said hook head, wherein said energy absorption area is a channel laterally passing through the left and right side of said hook body.

8. The anti-torque safety hook, as recited in claim 7, wherein said hook body has a symmetrically shaped front board and back board, wherein an end of said hook head is affixed between the top end of said front board and the top end of said back board in a clamping manner, wherein said hook eye has an intermediate block affixed between the bottom end of said front board and the bottom end of said back board in a clamping manner, wherein said hook head and said intermediate block control and keep said energy absorption area between the back side of said front board and the front side of said back board.

9. The anti-torque safety hook, as recited in claim 8, wherein said hook eye is formed by said intermediate block, a main bolt, and a breaking bolt, wherein said intermediate block has a covered portion and a bare portion, wherein said covered portion is clamped between the bottom end of said front board and the bottom end of said back board and affixed through the pinning of said main bolt and said breaking bolt, wherein the strength of said breaking bolt is lower than the strength of said main bolt, wherein said bare portion has a hanging hole penetrated thereon.

10. The anti-torque safety hook, as recited in claim 9, wherein said intermediate block has a chute arranged on said covered portion, wherein a guide bolt is provided and maintained to pass through said chute on said front board, said back board in the manner that when said breaking bolt has not been broken, said guide bolt is maintained at the original position in said chute, while when said breaking bolt is broken, said chute will position said guide bolt to a designated position, wherein said intermediate block further has a warning sign at said covered portion, so that when said breaking bolt has been broken, said warning sign will be revealed.

11. The anti-torque safety hook, as recited in claim 10, wherein said hook nose is formed by a slot communicated with said hook opening and a deep area connected with said slot, wherein a first groove penetrates said front board and said back board below said passage, wherein a second groove is arranged in a curvy manner for said first groove as the center, wherein the right side of said second groove is upwardly connected with a third groove, wherein said gate member has a baffle adapted for closing said opening and two side boards bently arranged on the two sides of said baffle respectively, wherein said two side boards respectively have a first end and a second end opposite arranged, wherein said first end covers said first groove and said third groove and bridges with a first axle that passes through said first groove and a second axle that passes through said third groove, wherein said second end of said two side boards bridges with a male buckle embedded in said deep area, so as for said gate member to close said opening, wherein when said opening is to be opened, said gate member has to be forced to shift downward, so as to drive said first axle to move to the lower portion of said first groove, said second axle to move to the lower portion of said second groove, and said male buckle to leave said deep area, rendering said gate member to swing toward said hook opening according to said first axle as the center thereof, which therefore drive said second axle to move along said second groove and decouple said male buckle from said hook nose.

12. The anti-torque safety hook, as recited in claim 11, further comprising a fourth groove arranged above said second groove on the left side of said front board and said back board, a first hole provided in the manner that said first groove, said second groove, said third groove, said fourth groove, and said first hole are all located on the lower portion of said energy absorption area, while said hook nose is correspondingly arranged on the upper portion of said energy absorption area, wherein said detent member is slidingly arranged on the lower portion of said energy absorption area and coupled with said first hole through said third axle, so as to allow said detent member to reach in and out in said fourth groove and switch between the first position and the second position, wherein said detent member has a fifth groove arranged thereon for said first axle to pass therethrough and a sixth groove arranged thereon matching with said second groove, wherein the right end of said sixth groove is opened and downwardly extended to provide a locking side, so that when said gate member closes said opening and said second axle is in said third groove, said locking side will abut against the bottom end of said second axle and position at the first position to ensure and secure that said gate member closes said opening, wherein when said detent member is switched to the second position, said locking side will release said second axle, rendering said sixth groove and said second groove overlappingly guide said second axle so as to allow said opening to be opened.

13. The anti-torque safety hook, as recited in claim 9, further comprising a spring mounted between said detent member and said intermediate block, so that said spring provides a predetermined force onto said detent member to grant said detent member a potential to stay at the first position.

14. An anti-torque safety hook, comprising:
a hook body;
a hook head, one end of which is connected to said hook body, and defines a hook opening that runs through the front and rear directions of said safety hook and forms an opening between the free end of said hook head and said hook body that communicates with the hook opening; and
a gate member, having a first end mounted on said main body and a second end comprising a male buckle, adapted for detachably coupled with said hook nose, so as to allow said gate member to open and close said opening, wherein the thickness of said hook body is greater than the thickness of said hook head, when the gate member closes the opening and the safety hook falls and collides, the hook body will first contact a collision object, and an impact force will be absorbed by the hook body first to ensure that the hook head does not deform and allows the gate member to close the opening.

15. The anti-torque safety hook, as recited in claim 14, further comprising a detent member, coupled on a main body and maintained at a first position, so as for ensuring that said gate member closes said opening, wherein when said detent member is operated and switched to a second position, the safety is disarmed, so that said gate member is operatable for opening said opening.

16. The anti-torque safety hook, as recited in claim 15, further comprising a hook eye mounted at the bottom of the hook body and located below the hook opening, wherein said hook eye is formed by said intermediate block, a main bolt, and a breaking bolt, wherein said intermediate block has a covered portion and a bare portion, wherein said covered portion is arranged at the bottom end of said hook body and affixed through the pinning of said main bolt and said breaking bolt, wherein the strength of said breaking bolt is lower than the strength of said main bolt, wherein said bare portion has a hanging hole penetrated thereon.

17. An anti-torque safety hook, comprising:
a hook head, having a hook nose arranged on the free end thereof;
a hook body, having a symmetrically shaped front board and back board, wherein an end of said hook head is affixed between the top end of said front board and the top end of said back board in a clamping manner to define a hook opening penetrated in the front and back direction of said safety hook and forms an opening between the free end of said hook head and said hook body that communicates with said hook opening;
a hook eye, which includes an intermediate block with a chute clamped and fixed between the bottom end of said front board and the bottom end of said back board, a main bolt that installs the intermediate block on said hook body, and a breaking bolt parallel to said main bolt and arranged on said hook body, and a guide bolt fixed to said hook body through said chute;
a gate member, having a first end mounted on said hook body and a second end comprising a male buckle, adapted for detachably coupled with said hook nose, so as to allow said gate member to open and close said opening; and
a detent member, coupled on a hook body and maintained at a first position, so as for ensuring that said gate member closes said opening, wherein when said detent member is operated and switched to a second position, the safety is disarmed, so that said gate member is operatable for opening said opening.

18. The anti-torque safety hook, as recited in claim 17, wherein an energy absorption area arranged on said hook body and located to the left side of said hook opening, a first resistance point located above said energy absorption area and at a position that said hook head is clamped between said back board and said front board, and a second resistance point located above said hook nose of said hook head, wherein the structural thickness of said first resistance point above said energy absorption area is symmetrically thickened compared to the structural thickness of said second resistance point above said hook nose of said hook head.

19. The anti-torque safety hook, as recited in claim 18, wherein said gate member opens said opening and is parallel to the longitudinal centerline formed by said hook body, a distance between said first resistance point and the top of said gate member is controlled to not exceed ⅛ inches.

20. The anti-torque safety hook, as recited in claim 19, wherein said intermediate block has a covered portion, a bare portion and a warning sign at said covered portion, wherein said covered portion is clamped between the bottom end of said front board and the bottom end of said back board and affixed through the pinning of said main bolt and said breaking bolt, wherein the strength of said breaking bolt is lower than the strength of said main bolt, wherein said bare portion has a hanging hole penetrated thereon, wherein when said breaking bolt is broken, said chute will position said guide bolt to a designated position, and said warning sign will be revealed.
